(19) United States
(12) Patent Application Publication
(10) Pub. No.: US 2006/0270356 A1
(43) Pub. Date: Nov. 30, 2006

(54) Multi-purpose communication device with electrical tester

(76) Inventors: Kwang Jin Oh, Fullerton, CA (US); Loren Oh, Fullerton, CA (US)

Correspondence Address: PARK LAW FIRM, 3255 WILSHIRE BLVD, SUITE 1110, LOS ANGELES, CA, 90010, US

(21) Appl. No.: 11/139,764

(22) Filed: May 27, 2005

(51) Int. Cl. H04B 17/00

(52) U.S. Cl. 455/67.11

(57) ABSTRACT

A multi-purpose communication device with electrical tester includes a communication unit and a sensing device, and the communication unit and the sensing device are encased in the case of the communication unit. The communication unit has a case, an antenna and display, and the sensing device has a probe, a sensing circuitry and an indicator. The communication unit includes a cellular phone. The sensing device detects the presence of electric voltage at a conductor. The probe of the sensing device is adapted to be inserted to the wall outlet. The indicator of the sensing device includes an LED lamp. The LED lamp turns on when electric voltage is detected at the conductor. The multi-purpose communication device further includes a pointing device. The pointing device includes a laser device. The laser device includes a laser pointer. The pointing device further includes an activating switch.

### BACKGROUND OF THE INVENTION

The present invention relates to a multi-purpose communication device with electrical tester. More particularly, this invention relates to a multi-purpose communication device which is combined with an electrical tester for detecting the presence of electrical voltage at a wire.

It would not be too wild to say that the mobile phone is replacing the fixed phone around the world these days. Since its appearance in 1970s, the mobile phone has kept reducing its size but enlarging its functions. Nowadays, a cutting-edge cellular phones weigh a few ounces only and are fitted in a palm.

If it was a watch that every grownup carried in 1960s, now it is definitely a cellular phone that almost every person including many children carries everywhere all the time in this beginning of 21^{st} century.

In the developed countries, the watch industry suffers just because of the digital clock built in the cellular phone.

Electrical engineers and technicians carry many kinds of equipment with them. A tester for checking if a wire is alive or not is one of basic tools that they bring for all their work hours.

Even though the engineers have a big tool box to keep all the tools and equipments, it might be very handy if one of tools, which is small enough and frequently used, is combined with the cellular phone.

There are still other good functions to be combined with the cell phone the people carry everywhere and every time. Such a gadget includes a temperature gauge, preferably using infrared rays, and a pointing device.

Those function can be built in one body, or built as a separated body, and then installed on a regular cell phone.

Accordingly, a need for a multi-purpose communication device with electrical tester has been present for a long time. This invention is directed to solve these problems and satisfy the long-felt need.

### SUMMARY OF THE INVENTION

An objective of the invention is to provide a multi-purpose communication device with electrical tester.

Another objective of the invention is to provide a multi-purpose communication device with electrical tester, which shares the display and the power source with the cellular phone.

Still another objective of the invention is to provide a multi-purpose communication device with electrical tester, which includes a laser pointer and a temperature gauge.

A multi-purpose communication device with electrical tester includes a communication unit and a sensing device. The communication unit has a case, an antenna, a circuitry, a portable power supply, and a display, and the sensing device has a probe, a sensing circuitry, and an indicator. The communication unit and the sensing device are encased in the case of the communication unit.

The communication unit includes a cellular phone.

The sensing device detects the presence of electric voltage at a conductor. The probe of the sensing device is adapted to be inserted to the wall outlet. The indicator of the sensing device includes an LED lamp, which turns on when electric voltage is detected at the conductor.

The sensing circuitry of the sensing device is adapted to decide the presence of electric voltage from signals from the probe and indicates the status with the indicator. The sensing device further includes an activating switch, wherein the activating switch selectively activates the communication unit or the sensing device.

The multi-purpose communication device further includes pointing device. The pointing device includes a laser device including a laser pointer. The pointing device further includes an activating switch.

The antenna of the communication unit is adapted to work as the probe of the sensing device or as a receptacle for an attached probe of the sensing device.

The display of the communication unit is adapted to work as the indicator of the sensing device.

The multi-purpose communication device further includes a temperature gauge. The temperature gauge includes a probe, a display, a power supply, and an activating switch. The temperature gauge shares the display and the power supply with the communication unit. The temperature gauge includes an infrared temperature gauge.

The sensing device or the pointing device can be provided in a separated body, and is attached to an external portion of the body of the communication unit.

In another embodiment, the sensing device includes a non-contact AC voltage detector, in which there is no external probe outwardly.

The advantages of the present invention are: (1) the multi-purpose communication device with electrical tester is handy to carry around and use; (2) the communication unit and the sensing devices can share the power supply and the display; (3) the multi-purpose communication device can work as a cellular phone, an electrical tester, a temperature gauge, and/or a laser pointer; (4) the electrical tester, temperature gauge, or laser pointer is provided in a body with the communication unit; (5) the electrical tester, temperature gauge, or laser pointer is provided in a separate body, which is attached to the bottom side or the rear side of the body of the communication unit.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is a front elevation view showing an embodiment of multi-purpose communication device with electrical tester;

FIG. 2 is a front elevation view showing another embodiment of multi-purpose communication device with electrical tester;

FIG. 3 is a front elevation view showing still another multi-purpose communication device with electrical tester;

FIG. 4 is a rear elevation view of the multi-purpose communication device;

FIG. 5 is a schematic circuit diagram for the electrical tester and the temperature gauge;

FIG. 6 is a block diagram showing the communication unit and the sensing devices;

FIG. 7 is a front elevation view of an electrical tester installed on the communication unit according to an embodiment; and

FIG. 8 is a side elevation view of an electrical tester installed on the communication unit according to another embodiment.

### DETAILED DESCRIPTION OF THE INVENTION

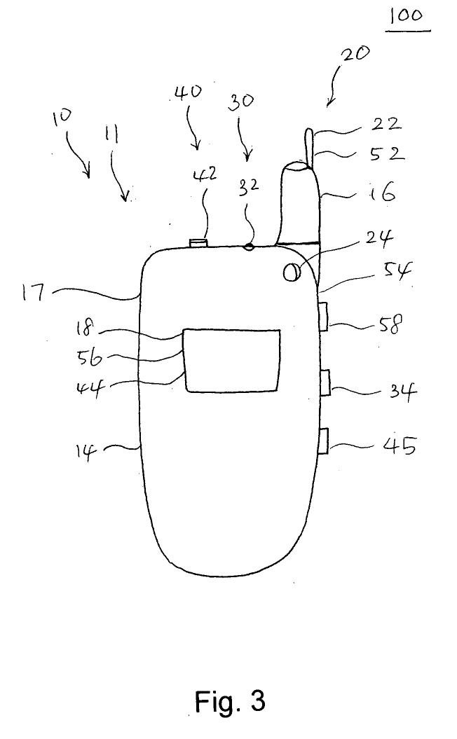

FIG. 3. 1 through 4 show the front and read elevation views of a multi-purpose communication device 100 according to the present invention.

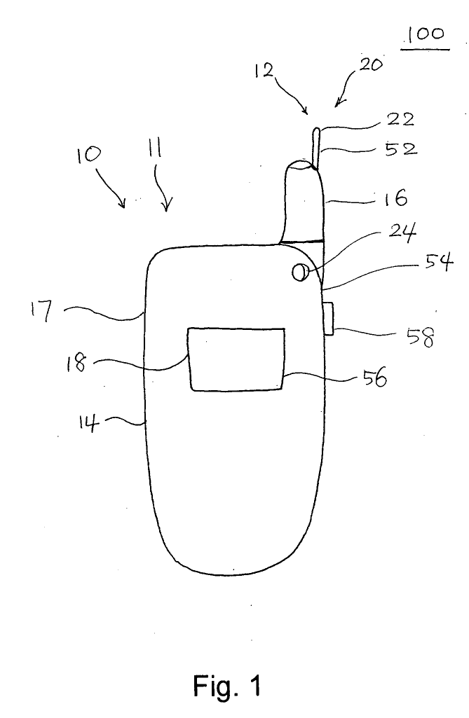

As shown in FIGS. 1 through 3, the multi-purpose communication device 100 with electrical tester includes a communication unit 10 and a sensing device 12. The communication unit 10 has a case 14, an antenna 16, a circuitry 17, a portable power supply 19, and a display 18. The sensing device 12 has a probe 52, a sensing circuitry 54, and an indicator 56. The sensing device 12 is encased in the case 14 of the communication unit 10. The communication unit 10 includes a cellular phone 11.

In an embodiment as shown in FIG. 1, the sensing device 12 is an electrical tester 20 for detecting the presence of electric voltage at a conductor. The probe 52 of the sensing device 12 is adapted to be inserted to the wall outlet or for receiving electromagnetic wave. Alternatively, the probe 22 is provided on the antenna 16 of the communication unit 10. The indicator 56 of the sensing device 12 includes an LED lamp 24. The LED lamp 24 turns on when electric voltage is detected at the conductor. Alternatively, the display 18 of the communication unit 10 is used as an indicator 56.

The sensing circuitry 54 of the sensing device is adapted to decide the presence of electric voltage from signals from the probe 52 and indicates the status with the indicator 56.

The sensing device 12 further includes an activating switch 58, which activates the sensing device 12.

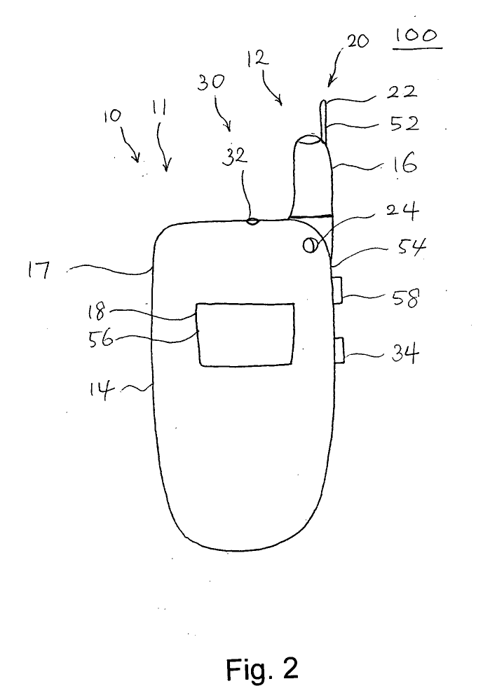

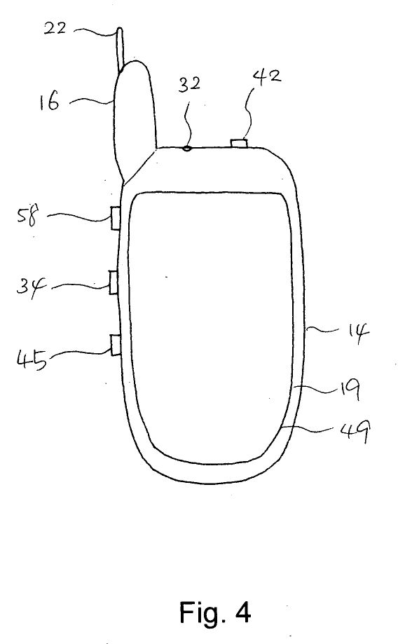

In another embodiment as shown in FIG. 2, the multi-purpose communication device 100 further includes a pointing device 30. The pointing device 30 includes a laser device, preferably a laser pointer 32 and a laser power circuitry 35 as shown in FIG. 4. The pointing device 30 further includes an activating switch 34.

The antenna 16 of the communication unit 10 is adapted to work as the probe 52 of the sensing device 12. More specifically, the probe 22 of the electrical tester 20 is provided on the tip of the antenna 16, and the probe 22 can be retracted in the antenna 16.

The sensing device 12 further includes a temperature gauge 40 as shown in FIG. 3 and FIG. 4. The temperature gauge 40 includes a sensor 42, a display 44, a power supply 49 and an activating switch 45. Alternatively, the temperature gauge 40 shares the display 18 with the communication unit 10. Also, the temperature gauge 40 shares the power supply 19 with the communication unit 10 and includes an activating switch 45. The temperature gauge 40 includes an infrared temperature gauge, which includes an infrared sensor 42.

As shown in FIG. 4, each function of the multi-purpose communication device 100 is activated by corresponding activating switches 58, 34, 45. The communication unit 10 and the sensing device 12 can share the display 18 and the power supply 19.

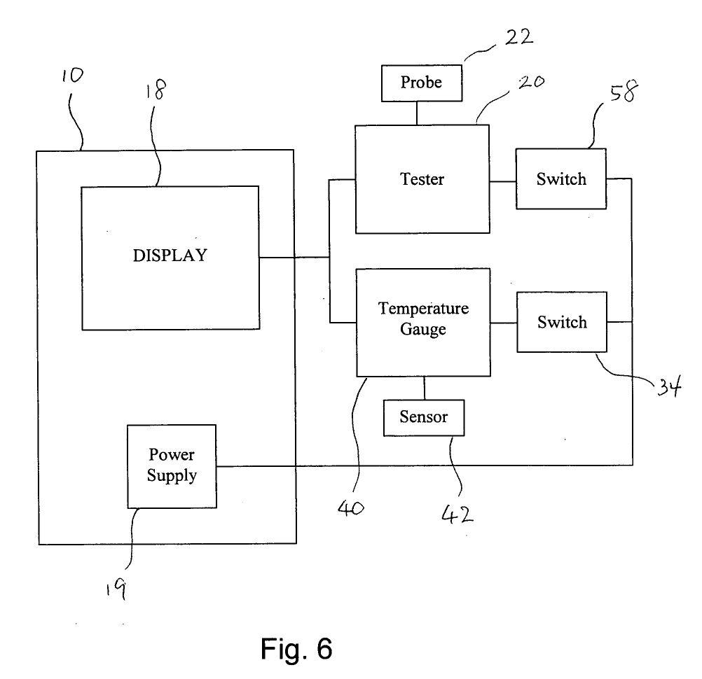

Actually, all the devices 10, 20, 30, 40 in the multi-purpose communication device 100 can share the power supply 19. And, the communication unit 10 and the sensing devices 20, 40 can share the display 18 as shown in FIG. 6.

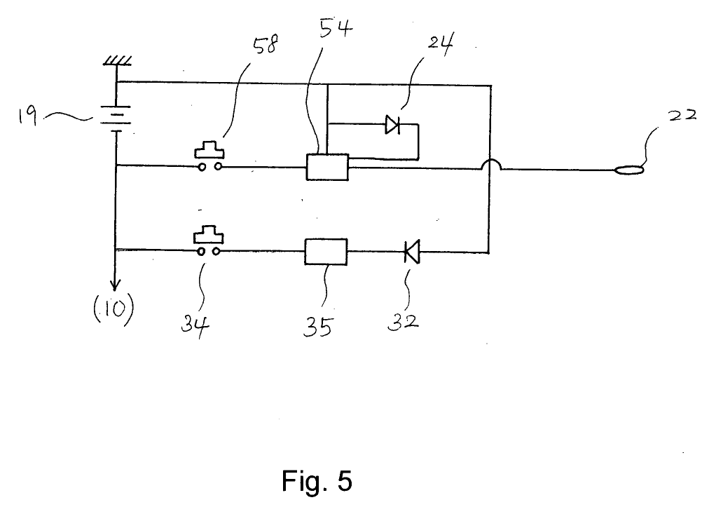

FIG. 5 shows a schematic circuit diagram of the electrical tester 10 and the pointing device 30. The activating switches 34, 58 are preferably push button switches. In still another embodiment, the output from the electrical tester 54 can operate a speaker (not shown) instead of the LEP lamp 24 to indicate the presence of electric voltage.

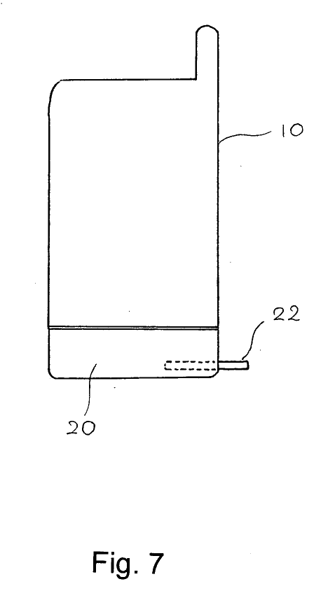

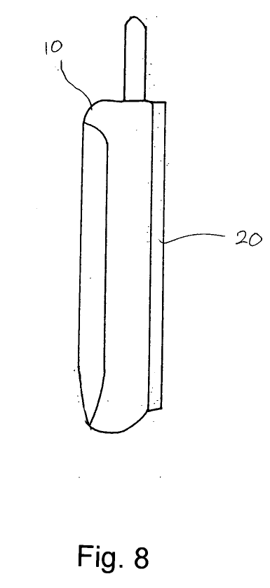

FIG. 7 and FIG. 8 show two alternative installation methods. The electrical tester 20, pointing device 30, and/or temperature gauge 40 can be built in one body as shown and explained in FIGS. 1 through 4. Alternatively, the electrical tester 20, pointing device 30, and/or temperature gauge 40 can be built in a separate body and then attached to a regular communication unit 10, in which the display 18 and the power supply 19 is still shared with an appropriate electrical and mechanical connecters. The separate electrical tester 20 is attached to the lower part of the communication unit 10, or attached to the rear side of the communication unit 10.

In another embodiment, the sensing device 12 includes a non-contact AC voltage detector, which has no external probe outwardly.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. A multi-purpose communication device with electrical tester comprising:
a) a communication unit having a case, an antenna, a circuitry, a portable power supply, and a display; and
b) a sensing divice having a probe, a sensing circuitry, and an indicator, wherein the communication unit and the sensing device are encased in the case of the communication unit.

2. The multi-purpose communication device of claim 1, wherein the communication unit comprises a cellular phone.

3. The multi-purpose communication device of claim 1, wherein the sensing device detects the presence of electric voltage at a conductor.

4. The multi-purpose communication device of claim 3, wherein the probe of the sensing device is adapted to be inserted to the wall outlet.

5. The multi-purpose communication device of claim 3, wherein the indicator of the sensing device comprises an LED lamp.

6. The multi-purpose communication device of claim 5, wherein the LED lamp turns on when electric voltage is detected at the conductor.

7. The multi-purpose communication device of claim 3, wherein the sensing circuitry of the sensing device is adapted to decide the presence of electric voltage from signals from the probe and indicates the status with the indicator.

8. The multi-purpose communication device of claim 3, wherein the sensing device further comprises an activating switch, wherein the activating switch selectively activates the communication unit or the sensing device.

9. The multi-purpose communication device of claim 1, further comprising a pointing device.

10. The multi-purpose communication device of claim 9, wherein the pointing device comprises a laser device.

11. The multi-purpose communication device of claim 10, wherein the laser device comprises a laser pointer.

12. The multi-purpose communication device of claim 9, wherein the pointing device further comprises an activating switch.

13. The multi-purpose communication device of claim 1, wherein the antenna of the communication unit is adapted to work as the probe of the sensing device.

14. The multi-purpose communication device of claim 1, wherein the display of the communication unit is adapted to work as the indicator of the sensing device.

15. The multi-purpose communication device of claim 1, wherein the sensing device further comprises a temperature gauge.

16. The multi-purpose communication device of claim 15, wherein the temperature gauge comprises a probe, a display, a power supply, and an activating switch.

17. The multi-purpose communication device of claim 16, wherein the temperature gauge shares the display with the communication unit.

18. The multi-purpose communication device of claim 16, wherein the temperature gauge shares the power supply with the communication unit.

19. The multi-purpose communication device of claim 15, wherein the temperature gauge comprises an infrared temperature gauge.

20. The multi-purpose communication device of claim 1, wherein the sensing device is provided in a separated body, wherein the sensing device is attached to an external portion of the body of the communication unit.

21. The multi-purpose communication device of claim 1, wherein the sensing device comprises a non-contact AC voltage detector.
